(19) United States
(12) Patent Application Publication
(10) Pub. No.: US 2020/0081126 A1
(43) Pub. Date: Mar. 12, 2020

(54) LASER RADAR DEVICE

(71) Applicant: Mitsubishi Electric Corporation, Tokyo (JP)

(72) Inventors: Yuichi NISHINO, Tokyo (JP); Yusuke ITO, Tokyo (JP); Masaharu IMAKI, Tokyo (JP); Shumpei KAMEYAMA, Tokyo (JP)

(73) Assignee: Mitsubishi Electric Corporation, Tokyo (JP)

(21) Appl. No.: 16/462,671

(22) PCT Filed: Jan. 11, 2017
(86) PCT No.: PCT/JP2017/000540

§ 371 Date: May 21, 2019

(51) Int. Cl. G01S 17/89; G01S 7/481; G01S 17/50

(52) U.S. Cl. CPC G01S 17/89; G01S 7/497; G01S 17/50; G01S 7/481

(57) ABSTRACT

A problem with a conventional laser radar device is that a deviation occurs between the receiving field of view and the beam incoming direction because of a change occurring between the angle of a scanner at the time of beam transmission and that at the time of beam reception, and the reception sensitivity degrades. A laser radar device of the present disclosure includes a light source for generating laser light, a modulator for modulating the laser light into transmission light, a scanner for irradiating a target with the transmission light modulated by the modulator, for receiving, as received light, reflected light from the target, and for steering the transmission light and the received light, an optical receiver for receiving the received light outputted by the scanner, a corrector disposed between the scanner and the optical receiver, for correcting an optical axis deviation caused by a deviation between the transmission angle of the transmission light and the reception angle of the received light, the deviation being caused by the scanner, in accordance with a time delay occurring between the transmission light and the received light, and a controller for calculating an amount of the optical axis deviation in accordance with the time delay, and for generating a control signal for controlling the corrector from the amount of the optical axis deviation.

### TECHNICAL FIELD

The present disclosure relates to laser radar devices.

### BACKGROUND ART

In range measurement that is performed by a laser radar device disclosed in Patent Literature 1 mentioned below, a target is irradiated with laser light, reflected light of the laser light that is reflected by the target and returns is then received, a received signal is acquired through heterodyne detection of the received light and local light of the transmission light, and the range to the target is calculated from the time difference with the laser irradiation start time.

### CITATION LIST

### Patent Literature

JP 2016-105082 A

### SUMMARY OF INVENTION

### Technical Problem

Because conventional laser radar devices operate as explained above, in a case of performing scanning using a coherent system capable of high sensitivity reception, a deviation occurs between the receiving field of view and the beam incoming direction because of a change occurring between the angle of the scanner (transmission angle) at the time of beam transmission and that (reception angle) at the time of beam reception, and the reception sensitivity degrades.

### Solution to Problem

According to the present disclosure, there is provided a laser radar device including: a light source for generating laser light; a modulator for modulating the laser light into transmission light; a scanner for emitting the transmission light modulated by the modulator toward a target, receiving, as received light, reflected light from the target, and steering the transmission light and the received light; an optical receiver for receiving the received light output from the scanner; a corrector provided between the scanner and the optical receiver, for correcting an optical axis deviation caused by a deviation caused by the scanner between a transmission angle of the transmission light and a reception angle of the received light, in accordance with a time delay occurring between the transmission light and the received light; and a controller for calculating an amount of the optical axis deviation in accordance with the time delay, and generating a control signal for controlling the corrector from the amount of the optical axis deviation.

### Advantageous Effects of Invention

According to embodiments of the present disclosure, the optical axis deviation caused because of a change occurring between the angle of the scanner at the time of beam transmission and the angle of the scanner at the time of beam reception can be corrected. As a result, even when the transmission light and the received light are steered using the scanner, ranges can be measured maintaining substantially the same signal to noise (SN) ratio as that obtained in a case in which scanning is not performed.

### BRIEF DESCRIPTION OF DRAWINGS

FIG. 1 is a block diagram showing an example of the configuration of a laser radar device according to Embodiment 1 of the present disclosure;

FIG. 2 is a flow chart showing an operation flow of a controller 8a according to Embodiment 1 of the present disclosure;

FIG. 3 is a voltage waveform view showing an example of an application voltage calculated by an application voltage calculating unit 822a according to Embodiment 1 of the present disclosure;

FIG. 4 is a block diagram showing an example of the configuration of a laser radar device according to Embodiment 2 of the present disclosure;

FIG. 5 is a flow chart showing an operation flow of a controller 8b;

FIG. 6 is an explanatory drawing showing a relation between the amount of movement Δd of a mirror and the amount of change Δx of received light, according to Embodiment 2 of the present disclosure; and

FIG. 7 is a voltage waveform view showing an example of an application voltage calculated by an application voltage calculating unit 822b according to Embodiment 2 of the present disclosure.

### DESCRIPTION OF EMBODIMENTS

### Embodiment 1

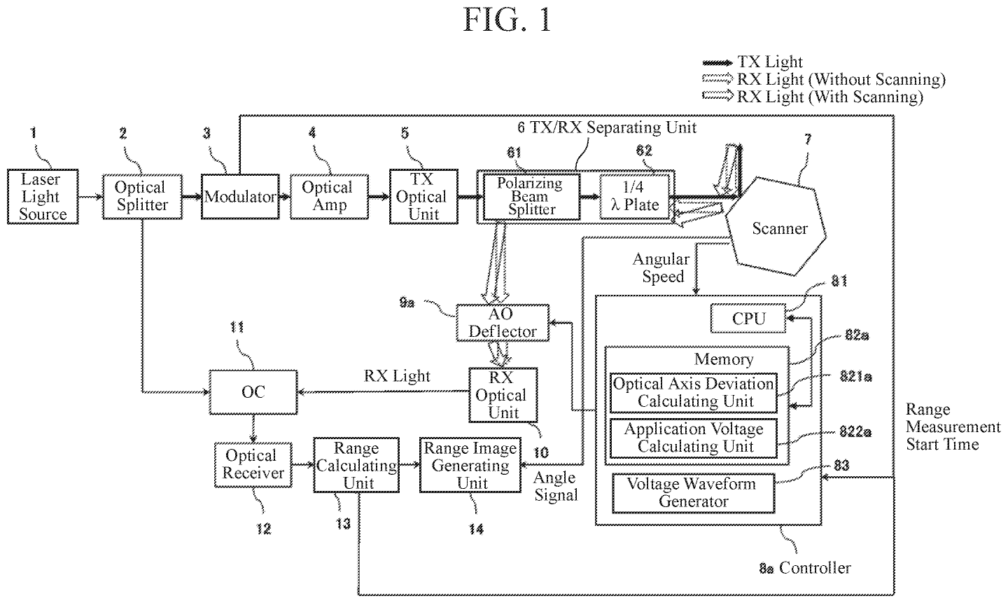

FIG. 1 is a block diagram showing an example of the configuration of a laser radar device according to Embodiment 1 of the present disclosure.

This laser radar device includes a laser light source 1, an optical splitter 2, a modulator 3, an optical amplifier 4, a transmission optical unit 5, a transmission/reception separating unit 6, a scanner 7, a controller 8a, an acoustic optic (AO) deflector 9a, a reception optical unit 10, an optical coupler 11, an optical receiver 12, a range calculating unit 13, and a range image generating unit 14.

The laser light source 1 (an example of a light source) outputs laser light to the optical splitter 2. Examples of the laser light source may include, for example, an integrable tunable laser assembly (ITLA) and a laser diode (LD). In a case in which an optical fiber for outputting laser light is included in the laser light source 1, the optical splitter 2 can be omitted and the optical fiber can be used by directly connecting it to the optical coupler 11.

The optical splitter 2 splits the laser light outputted by the laser light source 1 into two light beams, local light and transmission light, and outputs the local light to the optical coupler 11 and outputs the transmission light to the modulator 3. For example, as the optical splitter 2, an optical coupler or the like is used.

The modulator 3 (an example of a modulator) includes a signal generator for generating a trigger signal at a certain period, performs pulse modulation on the transmission light outputted by the optical splitter 2 in accordance with the trigger signal, and outputs the modulated transmission light to the optical amplifier 4. The modulator 3 outputs the trigger signal generated by the signal generator to the controller 8a. Here, because the trigger signal shows the rising time of a pulse, the trigger signal substantially shows a range measurement start time. For example, as the modulator, an LiNbO₃ (LN) intensity modulator is used. The modulator 3 may be configured to receive a trigger signal from the outside by providing the signal generator external to the modulator 3. In that case, a signal generator needs to be separately provided outside the modulator 3.

The optical amplifier 4 amplifies the transmission light on which the modulator 3 has performed pulse modulation, and outputs the amplified transmission light to the transmission optical unit 5. For example, as the optical amplifier 4, an erbium doped optical fiber amplifier (EDFA), a semiconductor optical amplifier (SOA), a wave guide amplifier (WGA), or the like is used.

The transmission optical unit 5 collimates the transmission light amplified by the optical amplifier 4 into light having a desired beam diameter and a desired divergence angle, and outputs the collimated transmission light to the transmission/reception separating unit 6. For example, as the transmission optical unit 5, a collimate lens, a condensing lens, or the like is used.

The transmission/reception separating unit 6 separates a route for transmission light and a route for received light. The transmission/reception separating unit 6 outputs the transmission light outputted by the transmission optical unit 5 to the scanner 7, and outputs the received light outputted by the scanner 7 to the AO deflector 9a.

For example, the transmission/reception separating unit 6 includes a polarizing beam splitter 61 and a ¼ wavelength plate 62. The transmission light passes through the polarizing beam splitter 61, and is outputted to the scanner 7. The received light is reflected by the polarizing beam splitter, and is outputted to the AO deflector 9a. In addition, in a case in which light outputted from the polarizing beam splitter is linearly polarized light, and it is necessary to convert the linearly polarized light into circularly polarized light, a ¼ wavelength plate is inserted at a stage following the polarizing beam splitter. In other cases, the transmission/reception separating unit 6 may use, for example, a ½ wavelength plate.

The scanner 7 (an example of a scanner) emits the transmission light toward a target and receives reflected light from the target as the received light, to scan a range of angle from which light can be received. Here, the receivable angle range is referred to as the receiving field of view. The scanning can be either one-dimensional scanning or two-dimensional scanning. Examples of the scanner 7 include, for example, a polygon scanner and a galvano scanner.

The controller 8a (an example of a controller) generates a control signal for correcting an optical axis deviation by using the angular speed of the scanner which is received from the scanner 7, and the measurement start time received from the modulator 3, and outputs the control signal to the AO deflector 9a. The controller 8a includes a central processing unit (CPU) 81, a memory 82a, and a voltage waveform generator 83.

The CPU 81 executes a program stored in the memory 82a.

The memory 82a includes an optical axis deviation calculating unit 821a and an application voltage calculating unit 822a. Here, the optical axis deviation calculating unit 821a and the application voltage calculating unit 822a refer to programs each of which is executed by the CPU 81.

The voltage waveform generator 83 generates a voltage waveform in accordance with an application voltage calculated by the application voltage calculating unit 822a, and outputs the voltage waveform generated thereby to the AO deflector 9a. For example, as the voltage waveform generator 83, a signal generator, an arbitrary waveform generator, or the like is used.

The AO deflector 9a (an example of a corrector) deflects the received light outputted by the scanner 7 in accordance with the control signal outputted by the controller 8a so as to correct the optical axis deviation. In the case of the one-dimensional scanning, the optical axis deviation is corrected using a single AO deflector, and, in the case of the two-dimensional scanning, the optical axis deviation is corrected using two AO deflectors. An AO deflector can respond at a high speed because its operating frequency is higher than that of a deflector of mechanical type. In addition, an AO deflector has a characteristic of not generating heat and being able to operate at a low voltage.

The reception optical unit 10 is a receiving unit for condensing the received light deflected by the AO deflector 9a, and outputting the received light to the optical coupler 11. For example, as the receiving unit, a collimate lens, a condensing lens, or the like is used.

The optical coupler 11 is an optical distributor for combining the local light outputted by the optical splitter 2 and the received light outputted by the reception optical unit 9, and outputting the combined light beam to the optical receiver 12. For example, as the optical coupler 11, a 4-port coupler, an optical combiner, or the like is used.

The optical receiver 12 (an example of an optical receiver) converts the light beam combined by the optical coupler 11 into an electric signal. For example, as the optical receiver 12, a photo detector, such as a photo diode (PD), an avalanche photo diode (APD), or a balanced receiver, is used.

The range calculating unit 13 calculates the range to the target by calculating a propagation delay time of the laser light on the basis of the time difference between the time that the trigger signal outputted by the modulator 3 is received, and the time that the electric signal outputted by the optical receiver 12 is received. Here, the time that the trigger signal outputted by the modulator 3 is received means the time that a received signal from a target 0m ahead is acquired. For example, the range calculating unit 13 is implemented by a semiconductor integrated circuit equipped with a CPU, a one chip microcomputer, a field-programmable gate array (FPGA), an application specific integrated circuit (ASIC), or the like.

The range image generating unit 14 generates a range image by plotting the range for the irradiation direction of each transmission light on the basis of the range value outputted by the range calculating unit 13. For example, the range image generating unit 14 is constituted by a semiconductor integrated circuit equipped with a CPU, a one chip microcomputer, an FPGA, an ASIC, or the like.

Next, the operation of the laser radar device according to Embodiment 1 of the present disclosure will be explained.

The laser light source 1 outputs laser light for irradiating a target to the optical splitter 2.

The optical splitter 2 splits the laser light outputted by the laser light source 1 into two light beams, local light and transmission light, and outputs the local light to the optical coupler 11 and outputs the transmission light to the modulator 3.

The modulator 3 performs the pulse modulation on the transmission light outputted by the optical splitter 2, and outputs the pulse modulated transmission light to the optical amplifier 4. Further, the modulator 3 outputs a trigger signal indicating a timing at which a range measurement is started to the controller 8a.

The optical amplifier 4 amplifies the transmission light on which the modulator 3 performs the pulse modulation, and outputs the amplified transmission light to the transmission optical unit 5.

The transmission optical unit 5 collimates the transmission light amplified by the optical amplifier 4 to light having a desired beam diameter and a desired divergence angle, and outputs the collimated transmission light to the transmission/reception separating unit 6.

The transmission/reception separating unit 6 outputs the transmission light that is collimated to have a desired beam shape by the transmission optical unit 5 to the scanner 7.

The scanner 7 reflects the transmission light and emits the transmission light toward a target. The emitted transmission light is reflected by the target. The scanner 7 receives the reflected light as received light and also reflects the received light, to output the received light to the transmission/reception separating unit 6. Further, the scanner 7 outputs the angular speed (ω [rad/s]) thereof to the controller 8a. Further, the scanner 7 outputs an angle signal to the range image generating unit 14. Here, the angle signal shows the mirror angle of the scanner.

The transmission/reception separating unit 6 outputs the received light outputted by the scanner 7 to the AO deflector 9a.

Here, the operation of the controller 8a will be explained.

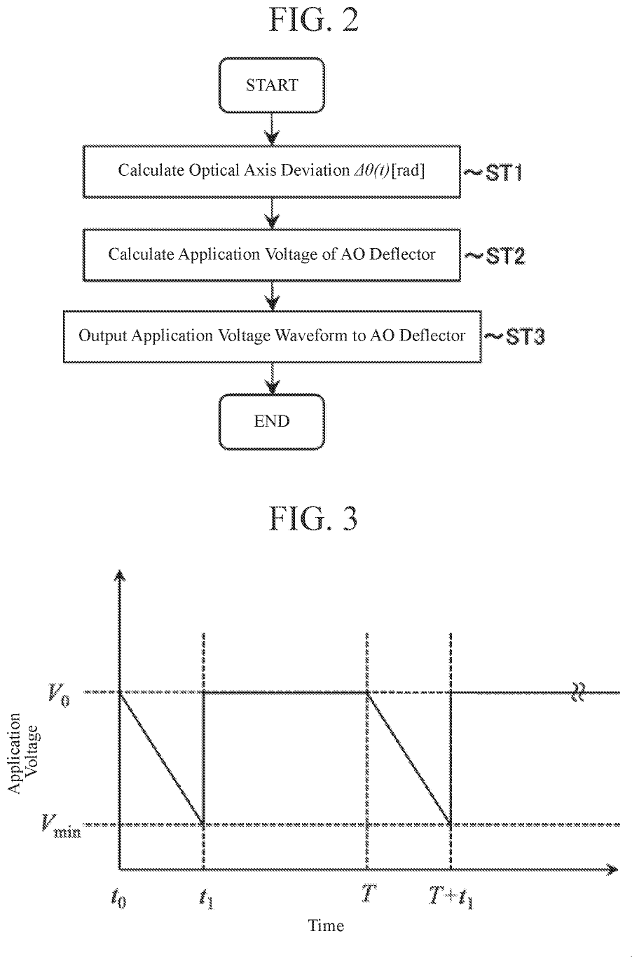

FIG. 2 is a flow chart showing an operation flow of the controller 8a according to Embodiment 1 of the present disclosure.

Instep ST1, the optical axis deviation calculating unit 821 receives the angular speed ω from the scanner 7, and calculates an optical axis deviation θ [rad]. When a time delay (a time which has elapsed since the range measurement start time) is expressed by t [s], the number of rotations of the scanner is expressed by N_{R} [rpm], a voltage which is needed in order to correct the optical axis deviation θ [rad] and which is applied to the AO deflector is expressed by V [V], and a proportional constant is expressed by A, relations among these parameters are expressed by the following equations.

$$\begin{matrix}[ Equation 1 ] & \\ V ( t ) = A \cdot θ ( t ) & ( 1 ) \\ [ Equation 2 ] & \\ \frac{Δ V ( t )}{Δ t} = A \cdot \frac{Δ θ ( t )}{Δ t} & ( 2 ) \\ [ Equation 3 ] & \\ θ ( t ) = \pm ω \cdot t & ( 3 ) \\ [ Equation 4 ] & \\ ω = 2 π \cdot \frac{{N}_{R}}{60} \cdot 2 & ( 4 )\end{matrix}$$

In Eq. (3), when the direction of rotation of the scanner is clockwise, the sign is negative, and when the direction of rotation of the scanner is counterclockwise, the sign is positive. The scanner 7 may be configured to output the number of rotations, instead of the angular speed, and the optical axis deviation calculating unit 821 may be configured to calculate the angular speed from the number of rotations, accordingly.

In step ST2, on the basis of a table showing a relation between the application voltage V of the AO deflector 9a and the deflection angle of emitted light from the AO deflector 9a, the application voltage calculating unit 822a calculates an application voltage with which the AO deflector 9a corrects the optical axis deviation θ. A relation between the optical axis deviation θ and the application voltage V of the AO deflector 9a may be stored, and V can be calculated directly from θ.

FIG. 3 illustrates a voltage waveform showing an example of the application voltage calculated by the application voltage calculating unit 822a according to Embodiment 1 of the present disclosure. FIG. 3 shows a case in which the scanner 7 rotates clockwise as an example.

In FIG. 3, the voltage V₀ [V] represents the application voltage of the AO deflector 9a when the optical axis deviation θ=0 [rad]. The minimum voltage Vₘᵢₙ [V] represents the application voltage of the AO deflector 9a when a maximum range is measured. Symbol t₀ [s] represents the range measurement start time (the trigger signal of the modulator 3). When the maximum measurement range is expressed by Lₘₐₓ [m] and the speed of light is expressed by c [m/s], the maximum delay time t₁ [s] can be expressed by the following equation.

$$\begin{matrix}[ Equation 5 ] & \\ {t}_{1} = \frac{2 {L}_{max}}{c} & ( 5 )\end{matrix}$$

When the repetition frequency of the laser is expressed by f [Hz], the period T [s] of the laser can be expressed by the following equation.

$$\begin{matrix}[ Equation 6 ] & \\ T = \frac{1}{f} & ( 6 )\end{matrix}$$

Within a time period from t₀ [s] to T [s], the voltage can be gradually increased from the minimum voltage Vₘᵢₙ [V] to the voltage V₀ [V], or the voltage can be fixed at the voltage V₀[V]. Because the control voltage is changed with respect to time in this way, even though the quantity of deviation θ of the optical axis changes with respect to time, the correction amount can be changed in accordance with the change. In other words, because the time is related to the measured range, even though the amount θ of optical axis deviation caused for the measured range differs, the optical axis deviation can be corrected.

Instep ST3, the voltage waveform generator 83 generates the application voltage calculated by the application voltage calculating unit 822a and outputs the generated application voltage to the AO deflector 9a, and the flow is ended.

The AO deflector 9a deflects the received light outputted by the transmission/reception separating unit 6 in accordance with the application voltage outputted by the controller 8a, to correct the optical axis deviation. The AO deflector 9a outputs the received light deflected thereby to the reception optical unit 10.

The reception optical unit 10 condenses the received light deflected by the AO deflector 9a, and outputs the condensed light to the optical coupler 11.

The optical coupler 11 combines the local light outputted by the optical splitter 2 and the received light outputted by the reception optical unit 10, and outputs the combined light to the optical receiver 12.

The optical receiver 12 converts the combined light outputted by the optical coupler 11 into an electric signal, and outputs the converted electric signal to the range calculating unit 13.

The range calculating unit 13 calculates the range Lₙ [m] to the target from the time difference tₙ [s] between the time that the trigger signal outputted by the modulator 3 is received, and the time that the electric signal outputted by the optical receiver 12 is received. Lₙ is expressed by the following equation. The range calculating unit 13 outputs the calculated Lₙ to the range image generating unit 14.

$$\begin{matrix}[ Equation 7 ] & \\ {L}_{n} = \frac{{ct}_{n}}{2} & ( 7 )\end{matrix}$$

When there occurs a difference (=an offset time) between the time that the trigger signal is received and the time that the laser light is emitted, the time difference tₙ [s] is expressed by the following equation by using the time t_{trg} [s] that the trigger signal is received, the offset time t_{off} [s], and the time tᵣ [s] that the electric signal outputted by the optical receiver 12 is received.

[Equation 8]

tₙ=(t_{trg}+t_{off})−tᵣ (8)

The range image generating unit 14 generates a range image showing two-dimensional or three-dimensional information about the target on the basis of the data Lₙ [m] about the acquired range value. Each data about the acquired range value is converted into three-dimensional data on the basis of the range value Lₙ and the angle signal of the scanner 7, and a range image is generated.

As is clear from the above description, according to Embodiment 1 of the present disclosure, because the optical axis deviation is calculated from the angular speed of the scanner 7, and, by using the AO deflector 9a, the optical axis deviation caused because of a change occurring between the angle of the scanner at the time of beam transmission and that at the time of beam reception is corrected in accordance with the time delay, the optical axis deviation can be corrected in accordance with the measured range. As a result, even when the scanner 7 performs scanning, ranges can be measured maintaining substantially the same signal to noise ratio (S/N ratio) as that obtained when no scanning is performed.

Although the case in which a one-dimensional optical axis deviation is corrected using a single AO deflector is shown above, an optical axis deviation in a two-dimensional direction can be corrected using two AO deflectors.

Further, although the AO deflector 9a is used in order to correct the optical axis deviation of the received light, a KTa₁₋ₓNbₓO₃ (KTN) scanner or a micro-electro-mechanical systems (MEMS) mirror can be used instead of the AO deflector. Because by applying a voltage to a KTN crystal its refractive index can be changed, the optical axis deviation can be corrected even when a high-speed operation is needed. In addition, because the KTN scanner has a higher transmissivity than the AO deflector, the reception efficiency can be prevented from decreasing.

### Embodiment 2

Although the laser radar device in the case of using an AO deflector in order to correct the optical axis deviation is explained in above-mentioned Embodiment 1, a laser radar device that uses a mirror and a piezo actuator, instead of an AO deflector, and provides a physical displacement by applying a voltage to the piezo actuator, to correct the optical axis deviation will be explained in Embodiment 2.

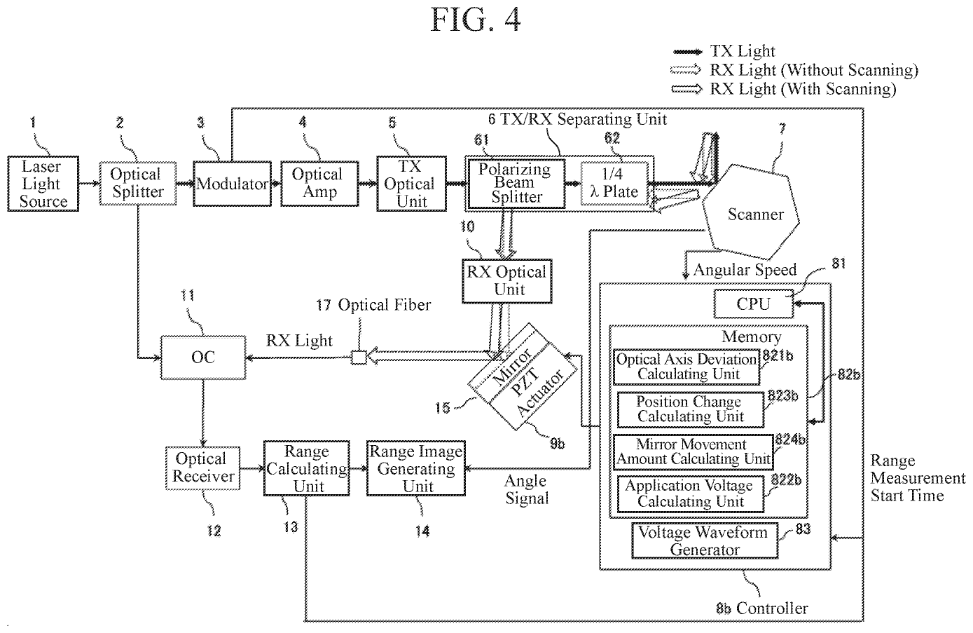

FIG. 4 is a block diagram showing an example of the configuration of the laser radar device according to Embodiment 2 of the present disclosure. In FIG. 4, because the same reference numerals as those shown in FIG. 1 denote the same components or like components, an explanation of the components will be omitted hereafter.

This figure differs from FIG. 1 in that a controller 8b is used instead of the controller 8a, a mirror 15 and a piezo actuator 9b are used instead of the AO deflector 9a, a reception optical unit 10 is located between a transmission/reception separating unit 6 and the mirror 15, and an optical fiber 17 is added between an optical coupler 11 and the mirror 15.

The controller 8b generates a control signal for correcting the optical axis deviation by using the angular speed of a scanner 7 which is received from the scanner, and a measurement start time received from a modulator 3, and outputs the control signal to the piezo actuator 9b. The controller 8b includes a central processing unit (CPU) 81, a memory 82b, and a voltage waveform generator 83.

The memory 82b includes an optical axis deviation calculating unit 821b, an application voltage calculating unit 822b, a position change calculating unit 823b, and a mirror movement amount calculating unit 824b. Here, the optical axis deviation calculating unit 821b, the application voltage calculating unit 822b, the position change calculating unit 823b, and the mirror movement amount calculating unit 824b refer to programs executed by the CPU 81.

The piezo actuator 9b moves the mirror 15 on the basis of the control signal outputted by the controller 8a, to correct the optical axis deviation.

The mirror 15 reflects received light condensed by the reception optical unit 10, to couple the received light to the optical fiber 17. For example, as the mirror 15, a reflecting mirror independent of the wavelength of a laser light source to be used, such as a mirror with metallic coating, is used.

Next, the operation of the laser radar device according to Embodiment 2 of the present disclosure will be explained. An explanation of the same or like operations as those of Embodiment 1 will be omitted hereafter.

Because the operations of units from the laser light source 1 to the scanner 7 are the same as those of Embodiment 1, an explanation of the operations will be omitted and the operation of the controller 8b will be explained first.

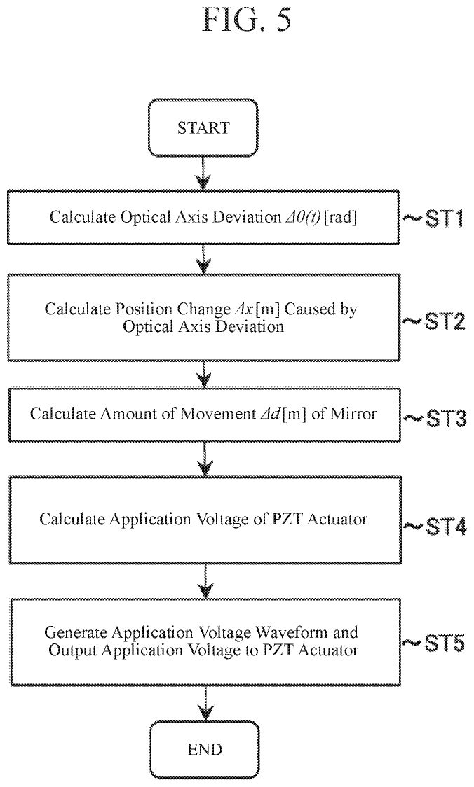

FIG. 5 is a flow chart showing an operation flow of the controller 8b.

In step ST1, the optical axis deviation calculating unit 821b receives an angular speed ω from the scanner 7, and calculates an optical axis deviation θ [rad] by using the same method as that of Embodiment 1. More specifically, θ is calculated from the angular speed ω and a time delay t.

In step ST2, the position change calculating unit 823b approximately calculates an amount of position change Δx [m] of the received light caused by the optical axis deviation, from the optical axis deviation θ [rad] and the focal length f [m] of a lens of the reception optical unit 10, by using the following equation. The position change calculating unit 823b outputs the calculated Δx to the mirror movement amount calculating unit 824b.

[Equation 9]

Δx=f·tan θ (9)

In step ST3, the mirror movement amount calculating unit 824b calculates an amount of movement Δd [m] of the mirror for correcting the optical axis deviation from Δx calculated by the position change calculating unit 823b, and outputs the calculated Δd to the application voltage calculating unit 822b.

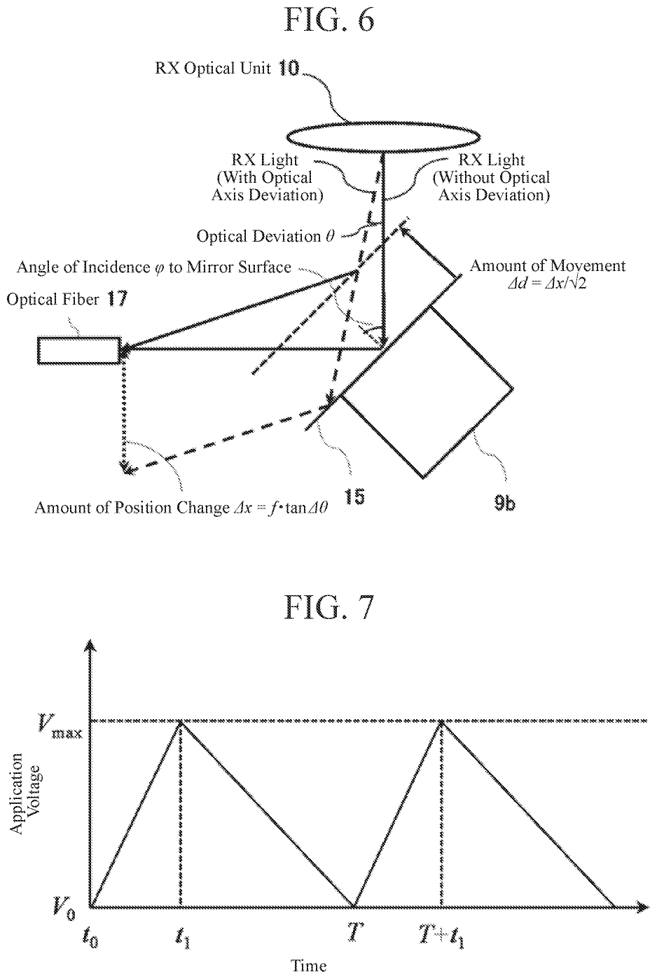

FIG. 6 is an explanatory drawing showing a relation between the amount of movement Δd of the mirror according to Embodiment 2 of the present disclosure and the amount of position change Δx of the received light. Solid lines denote the received light in a case in which there is no optical axis deviation, and broken lines denote the received light in a case in which there is an optical axis deviation. Because, in the case in which there is an optical axis deviation, the point where the received light is reflected by the mirror 15 deviates compared with the case in which there is no optical axis deviation, there occurs a positional deviation of the reflected light and the coupling of the light to the optical fiber 17 fails (the reflected light does not enter the optical fiber). By moving the mirror 15 by using the piezo actuator 9b, the light reflected by the mirror 15 is coupled to the optical fiber 17.

For example, when the angle of incidence on the mirror surface is π/4 [rad], the amount of movement Δd [m] of the mirror for correcting the optical axis deviation can be expressed by the following equation.

$$\begin{matrix}[ Equation 10 ] & \\ Δ d = \frac{Δ x}{\sqrt{2}} & ( 10 )\end{matrix}$$

In step ST4, the application voltage calculating unit 822b calculates a voltage for controlling the piezo actuator 9b on the basis of a table showing a relation between the voltage V applied to the piezo actuator 9b and the amount of movement Δd. The application voltage calculating unit 822b outputs the calculated control voltage V to the voltage waveform generator 83. When the angle of incidence on the mirror surface is (ϕ) [rad], the amount of movement Δd [m] of the mirror for correcting the optical axis deviation can be expressed by the following equation.

$$\begin{matrix}[ Equation 11 ] & \\ Δ d = Δ x \cdot sin ( \frac{π}{2} - φ ) & ( 11 )\end{matrix}$$

FIG. 7 illustrates a voltage waveform showing an example of the application voltage calculated by the application voltage calculating unit 822b according to Embodiment 2 of the present disclosure. In FIG. 7, a vertical axis shows the application voltage, and a horizontal axis shows a time.

As shown in FIG. 7, the application voltage calculating unit 822b sets the application voltage to V₀ [V] at a time t₀ [s], and sets the application voltage to Vₘₐₓ [V] at a maximum range measurement time t₁ [s]. Symbol t₀ is the time that the controller 8b receives a trigger signal outputted by the modulator 3, and is substantially a range measurement start time. The application voltage Vₘₐₓ [V] is the one that is needed in order to correct the optical axis deviation occurring when a maximum measurement range Lₘₐₓ [m] is measured, and that is applied to the piezo actuator. Here, the maximum range measurement range Lₘₐₓ [m] is stored in the memory 82b in advance. Because the control voltage is changed with respect to time in this way, the optical axis deviation can be corrected for all measured ranges, as in the case of Embodiment 1. Although the case in which the application voltage waveform of FIG. 7 is a triangular one is shown as an example, the application voltage waveform can be a sinusoidal one. This is because a sinusoidal wave can be assumed to be approximately a triangular wave when points other than the inflection points of the sinusoidal wave are used.

Instep ST5, the voltage waveform generator 83 generates the control voltage calculated by the application voltage calculating unit 822b and outputs the control voltage to the piezo actuator 9b, and the flow is ended.

The piezo actuator 9b moves the mirror 15 in accordance with the control signal outputted by the voltage waveform generator 83, to correct the optical axis deviation. The received light in which the optical axis deviation is corrected is inputted to the optical fiber 17. The optical fiber 17 outputs the received light inputted thereto to the optical coupler 11.

Because the operations of units following the optical coupler 11 are the same as those of Embodiment 1, an explanation of the operations will be omitted hereafter.

As previously explained, according to Embodiment 2, because the piezo actuator 9b is used and the received light is reflected by the mirror 15, and the optical axis deviation is corrected, there is provided an advantage of being able to increase the reflectivity of the received light and prevent decrease in the reception efficiency. Further, in the case in which the piezo actuator 9b and the mirror 15 are used, because there is no dependence on the wavelength of the received light and the optical axis deviation can be corrected, there is also provided an advantage of increasing the degree of flexibility of the output wavelength of the laser light source 1. This configuration can also support a case in which the laser light source 1 changes the output wavelength, and a case in which multiple light beams having different wavelengths are outputted.

In the case in which an AO deflector is used, the wavelength to be used is limited by the AO deflector. In contrast, in the case in which a piezo actuator is used, there is no dependence on the wavelength because the positional deviation of the optical axis can be corrected by a mirror. Therefore, even in a case in which a laser light source that can change the wavelength is used, the optical axis deviation can be corrected.

### REFERENCE SIGNS LIST

1 laser light source, 2 optical splitter, 3 modulator, 4 optical amplifier, 5 transmission optical unit, 6 transmission/reception separating unit, 7 scanner, 8a 8b controller, 9a AO deflector, 9b piezo actuator, 10 reception optical unit, 11 optical coupler, 12 optical receiver, 13 range calculating unit, 14 range image generating unit, 15 mirror, 17 optical fiber, 61 polarizing beam splitter, 62 ¼ wavelength plate, 81 CPU, 82a 82b memory, 83 voltage waveform generator, 821a 821b optical axis deviation calculating unit, 822a 822b application voltage calculating unit, 823b position change calculating unit, and 824b mirror movement amount calculating unit.

1. A laser radar device comprising:
a light source for generating laser light;
a modulator for modulating the laser light into transmission light;
a scanner for emitting the transmission light modulated by the modulator toward a target, receiving, as received light, reflected light from the target, and steering the transmission light and the received light;
an optical receiver for receiving the received light output from the scanner;
an AO deflector provided between the scanner and the optical receiver, for correcting an optical axis deviation caused by a deviation caused by the scanner between a transmission angle of the transmission light and a reception angle of the received light, by deflecting the received light output from the scanner in accordance with a time delay occurring between the transmission light and the received light; and
a controller for calculating an amount of the optical axis deviation in accordance with the time delay, and generating a control signal for controlling the AO deflector from the amount of the optical axis deviation.

2. The laser radar device according to claim 6, wherein the controller receives a signal showing a timing of pulse modulation from the modulator, receives an angular speed at a time of steering the transmission light and the received light from the scanner, and calculates the optical axis deviation amount from both the timing and the angular speed.

3-5. (canceled)

6. The laser radar device according to claim 1, further comprising:
an optical coupler for combining the laser light output from the light source and the received light corrected by the AO deflector; and
the optical receiver for converting light combined by the optical coupler into an electrical signal.
